(19) United States
(12) Patent Application Publication
(10) Pub. No.: US 2003/0026226 A1
(43) Pub. Date: Feb. 6, 2003

(54) Public communication system and public communication method

(75) Inventor: Tetsuya Miura, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/197,175

(22) Filed: Jul. 18, 2002

(30) Foreign Application Priority Data
Jul. 19, 2001 (JP) 2001-220421

(51) Int. Cl. H04B 7/216

(52) U.S. Cl. 370/335; 375/130

(57) ABSTRACT

A public communication system and method is disclosed which can provide a necessary high speed service flexibly when necessary. A W-CDMA system is used to integrate a plurality of communication networks having different service objects from one another such as a medical (fire service) network, a police network, undertaker networks and a general public network to construct a single common communication system. User terminals such as medical (fire service) high function mobile communication terminals, police high function mobile communication terminals, undertaker high function mobile communication terminals and portable telephone terminals are connected to the W-CDMA system through the air interface. The common communication system controls so that baseband resources are allocated to the user terminals based on priority levels of the user terminals.

### BACKGROUND OF THE INVENTION

1. Field of the Invention

The present invention relates to a public communication system, and more particularly to a public communication system wherein a plurality of communication systems are integrated by a W-CDMA system to provide a necessary high speed service flexibly to a mobile communication terminal when necessary.

2. Description of the Related Art

Conventionally, a public communication system including an emergency communication system is constructed for each service object.

For example, in a police communication system, police mobile communication terminals are accommodated in a police network by leased lines. Meanwhile, in a medical communication system, medical mobile communication terminals are accommodated in a medical network by leased lines.

Any of mobile communication terminals of the types described is used for emergency communication in accordance with an object thereof over the pertaining network at a communication rate given thereto advance.

When such mobile communication terminals as described above are used for emergency communication, they must be able to transmit and receive a great amount of data.

For example, when a patent is carried by an ambulance car for lifesaving emergency, a medical mobile communication terminal installed in the ambulance car must transmit and receive a great amount of data at a high rate so that the patient may be treated appropriately on the ambulance car.

Since such conventional emergency communication systems as described above are configured such that a mobile communication terminal communicates at a signaling rate given fixedly thereto in advance, they sometimes fail to allocate, or to immediately allocate, a resource which can process the signaling rate to the mobile communication terminal because of traffic congestion. The conventional emergency communication systems therefore have a subject to be solved in that they cannot establish a call connection or requires much time to establish a call connection, resulting in failure in emergency communication or in loss of the significance of emergency communication.

Further, since the conventional emergency communication systems are constructed individually for the individual objects, when any of the emergency communication systems fails to allocate a resource which can treat a pertaining signaling rate to a mobile communication terminal because of traffic congestion, it cannot allocate a free resource owned by another one of the emergency communication systems. Therefore, the conventional emergency communication systems have a subject to be solved in that they are poor in flexibility of resources and cannot provide a service with a high degree of freedom to a mobile communication terminal.

### SUMMARY OF THE INVENTION

It is an object of the present invention to provide a public communication system and a public communication method which can provide a necessary high speed service flexibly to a mobile communication terminal when necessary.

In order to attain the object described above, according to an aspect of the present invention, there is provided a public communication system, comprising a plurality of communication networks having different service objects from each other, a plurality of mobile communication terminals for communicating with the communication networks, and a W-CDMA system for integrally connecting the communication networks and using the W-CDMA to set, individually for the mobile communication terminals, transmission rates to be used for communication by the mobile communication terminals based on priority levels determined in advance and connect the mobile communication terminals and the communication networks for communication to each other at the set transmission rates.

The W-CDMA system may include a mobile communication exchange, a plurality of radio base station apparatus and a base station control apparatus for communicating with the mobile communication exchange to control the plurality of radio base station apparatus, the mobile communication exchange including network means for connecting the communication networks to each other and terminal and network connection means for connecting the mobile communication terminals to the communication networks, each of the radio base station apparatus including resource controlling means for controlling so that, for each of the mobile communication terminals, a band resource for a transmission rate to be allocated to the mobile communication terminal is secured based on the priority level determined in advance for the mobile communication terminal, resource allocation means for allocating the band resources secured by the resource controlling means individually to the mobile communication terminals, baseband processing means for baseband processing a signal of any of the mobile communication terminals with the band resource allocated to the mobile communication terminal by the resource allocation means, and air interface means for radio interfacing the signal baseband processed by the baseband processing means with the pertaining mobile communication terminal using the W-CDMA air interface.

The resource controlling means may include first controlling means for controlling so that at the worst a band resource which can process a minimum transmission rate requested by the pertaining mobile communication terminal is secured, second controlling means for controlling so that at the worst a band resource which can process a medium transmission rate requested by the pertaining mobile communication terminal and higher than the minimum transmission ratio but lower than a maximum transmission rate is secured, and third controlling means for controlling so that a band resource which can process the maximum transmission rate requested by the pertaining mobile communication terminal is secured.

The resource controlling means may attempt to secure, for the pertaining mobile communication terminal, a band resource which can process the maximum transmission rate by means of the third controlling means and control, when the band resource cannot be secured, to release another band resource allocated to another one of the mobile communication terminals having a priority level lower than the priority level of the pertaining mobile communication terminal and secure, for the pertaining mobile communication terminal, the band resource which can process the maximum transmission rate.

As an alternative, the resource controlling means may attempt to secure, for the pertaining mobile communication terminal, a band resource which can process the maximum transmission rate by means of the third controlling means and control, when the band resource cannot be secured, to change another band resource allocated to another one of the mobile communication terminals having a priority level lower than the priority level of the pertaining mobile communication terminal to a further band resource which can process a lower transmission rate and secure, for the pertaining mobile communication terminal, the band resource which can process the maximum transmission rate.

As another alternative, the resource controlling means may first attempt to secure, for the pertaining mobile communication terminal, a band resource which can process the maximum transmission rate by means of the third controlling means and then attempt, when the band resource cannot be secured, to secure, for the pertaining mobile communication terminal, another band resource which can process a medium transmission rate by means of the second controlling means, and then control, when the band resource cannot be secured, to release a further band resource allocated to another one of the mobile communication terminals having a priority level lower than the priority level of the pertaining mobile communication terminal and secure, for the pertaining mobile communication terminal, the band resource which can process the medium transmission rate.

As a further alternative, the resource controlling means may first attempt to secure, for the pertaining mobile communication terminal, a band resource which can process the maximum transmission rate by means of the third controlling means and then attempt, when the band resource cannot be secured, to secure, for the pertaining mobile communication terminal, another band resource which can process a medium transmission rate by means of the second controlling means, and then control, when the band resource cannot be secured, to change another band resource allocated to another one of the mobile communication terminals having a priority level lower than the priority level of the pertaining mobile communication terminal to a further band resource which can process a lower transmission rate and secure, for the pertaining mobile communication terminal, the band resource which can process the medium transmission rate.

As a still further alternative, the resource controlling means may first attempt to secure, for the pertaining mobile communication terminal, a band resource which can process the maximum transmission rate by means of the third controlling means and then attempt, when the band resource cannot be secured, to secure, for the pertaining mobile communication terminal, another band resource which can process a medium transmission rate by means of the second controlling means, and further attempt, when the band resource cannot be secured, to secure, for the pertaining mobile communication terminal, a further band resource which can process the minimum transmission rate by the first controlling means, whereafter the resource controlling means controls, when the band resource cannot be secured, to release a still further band resource allocated to another one of the mobile communication terminals having a priority level lower than the priority level of the pertaining mobile communication terminal and secure, for the pertaining mobile communication terminal, the band resource which can process the minimum transmission rate.

As a yet further alternative, the resource controlling means may first attempt to secure, for the pertaining mobile communication terminal, a band resource which can process the maximum transmission rate by means of the third controlling means and then attempt, when the band resource cannot be secured, to secure, for the pertaining mobile communication terminal, another band resource which can process a medium transmission rate by means of the second controlling means, and further attempt, when the band resource cannot be secured, to secure, for the pertaining mobile communication terminal, a further band resource which can process the minimum transmission rate by the first controlling means, whereafter the resource controlling means controls, when the band resource cannot be secured, to change a still further band resource allocated to another one of the mobile communication terminals having a priority level lower than the priority level of the pertaining mobile communication terminal to a yet further band resource which can process a lower transmission rate and secure, for the pertaining mobile communication terminal, the band resource which can process the minimum transmission rate.

The resource allocation means may define a band resource which can process a minimum transmission rate as a basic unit band resource and allocate, to the pertaining mobile communication terminal, one or a plurality of basic unit band resources under the control of the resource control means.

Each of the mobile communication terminals may include a W-CDMA basic terminal function section, an information apparatus interface, a plurality of information apparatus and a handset for telephone communication, the W-CDMA basic terminal function section having a function of controlling a basic call process of the W-CDMA, a function of processing the air interface of the W-CDMA, a function of sending downlink user data received from the W-CDMA system to the information apparatus interface, and a function of converting the data into data of the air interface of the W-CDMA, the information apparatus interface having the W-CDMA basic terminal function section and a function of interfacing between the plurality of interface apparatus and the handsets of the mobile communication terminals.

The interface apparatus interface of the mobile communication terminals may have an interface common to the plurality of information apparatus.

According to another aspect of the present invention, there is provided a public communication method by a plurality of communication networks having different service objects from each other, a plurality of mobile communication terminals for communicating with the communication networks, and a W-CDMA for integrally connecting the communication networks and using the W-CDMA to connect the mobile communication terminals for communication to each other, comprising a network connection step of connecting the communication networks to each other, a resource controlling step of controlling to secure, for each of the mobile communication terminals, a band resource for a transmission rate to be allocated to the mobile communication terminal based on a priority level determined in advance for the mobile communication terminal, a resource allocation step of allocating, to each of the mobile communication terminals, the band resource secured by the resource controlling step, a baseband processing step of baseband processing signals of the mobile communication terminals with the band resources allocated thereto by the resource allocation step, an air interface step of radio interfacing the signals processed by the baseband processing step individually with the mobile communication terminals using a W-CDMA interface, and a terminal and network connection step of connecting the mobile communication terminals to the communication networks, the steps being performed by the W-CDMA system.

The resource controlling step may include a first controlling step of controlling so that at the worst a band resource which can process a minimum transmission rate requested by the pertaining mobile communication terminal is secured, a second controlling step of controlling so that at the worst a band resource which can process a medium transmission rate requested by the pertaining mobile communication terminal and higher than the minimum transmission ratio but lower than a maximum transmission rate is secured, and a third controlling step of controlling so that a band resource which can process the maximum transmission rate requested by the pertaining mobile communication terminal is secured.

As an alternative, the resource controlling step may include a step of attempting to secure, for the pertaining mobile communication terminal, a band resource which can process a maximum transmission rate by the third controlling step and a step of controlling, when the band resource cannot be secured, to release another band resource allocated to another one of the mobile communication terminals having a priority level lower than the priority level of the pertaining mobile communication terminal and secure, for the pertaining mobile communication terminal, the band resource which can process the maximum transmission rate.

As another alternative, the resource controlling step may include a step of attempting to secure, for the pertaining mobile communication terminal, a band resource which can process a maximum transmission rate by the third controlling step and a step of controlling, when the band resource cannot be secured, to change another band resource allocated to another one of the mobile communication terminals having a priority level lower than the priority level of the pertaining mobile communication terminal to a further band resource which can process a lower transmission rate and secure, for the pertaining mobile communication terminal, the band resource which can process the maximum transmission rate.

As a further alternative, the resource controlling step may include a first step of attempting to secure, for the pertaining mobile communication terminal, a band resource which can process a maximum transmission rate by the third controlling step, a second step of attempting, when the band resource cannot be secured, to secure, for the pertaining mobile communication terminal, another band resource which can process a medium transmission rate by the second controlling step, and a third step of controlling, when the band resource cannot be secured, to release a further band resource allocated to another one of the mobile communication terminals having a priority level lower than the priority level of the pertaining mobile communication terminal and secure, for the pertaining mobile communication terminal, the band resource which can process the medium transmission rate.

As a still further alternative, the resource controlling step may include a first step of attempting to secure, for the pertaining mobile communication terminal, a band resource which can process a maximum transmission rate by the third controlling step, a second step of attempting, when the band resource cannot be secured, to secure, for the pertaining mobile communication terminal, another band resource which can process a medium transmission rate by the second controlling step, and a third step of controlling, when the band resource cannot be secured, to change another band resource allocated to another one of the mobile communication terminals having a priority level lower than the priority level of the pertaining mobile communication terminal to a further band resource which can process a lower transmission rate and secure, for the pertaining mobile communication terminal, the band resource which can process the medium transmission rate.

As a yet further alternative, the resource controlling step may include a first step of attempting to secure, for the pertaining mobile communication terminal, a band resource which can process a maximum transmission rate by the third controlling step, a second step of attempting, when the band resource cannot be secured, to secure, for the pertaining mobile communication terminal, another band resource which can process a medium transmission rate by the second controlling step, a third step of attempting, when the band resource cannot be secured, to secure, for the pertaining mobile communication terminal, a further band resource which can process a minimum transmission rate by the first controlling step, and a fourth step of controlling, when the band resource cannot be secured, to release a still further band resource allocated to another one of the mobile communication terminals having a priority level lower than the priority level of the pertaining mobile communication terminal and secure, for the pertaining mobile communication terminal, the band resource which can process the minimum transmission rate.

As an additional alternative, the resource controlling step may include a first step of attempting to secure, for the pertaining mobile communication terminal, a band resource which can process the maximum transmission rate by the third controlling step, a second step of attempting, when the band resource cannot be secured, to secure, for the pertaining mobile communication terminal, another band resource which can process a medium transmission rate by the second controlling step, a third step of attempting, when the band resource cannot be secured, to secure, for the pertaining mobile communication terminal, a further band resource which can process a minimum transmission rate by the first controlling step, and a fourth step of controlling, when the band resource cannot be secured, to change a still further band resource allocated to another one of the mobile communication terminals having a priority level lower than the priority level of the pertaining mobile communication terminal to a yet further band resource which can process a lower transmission rate and secure, for the pertaining mobile communication terminal, the band resource which can process the minimum transmission rate.

The resource allocation step may define a band resource which can process a minimum transmission rate as a basic unit band resource and allocate, to the pertaining mobile communication terminal, one or a plurality of basic unit band resources under the control of the resource control step.

With the public communication system and the public communication method, since the W-CDMA is used to integrate a plurality of communication networks having different service objects from one another to construct a single public communication system, there is an advantage that a necessary high speed service can be provided flexibly when necessary.

Further, since the W-CDMA is used to integrate a plurality of communication networks having different service objects from one another to construct a single public communication system such that there is no necessity to prepare a plurality of different frequencies to be used for accessing to a plurality of communication networks for users, there is another advantage that frequency resources can be saved.

The above and other objects, features and advantages of the present invention will become apparent from the following description and the appended claims, taken in conjunction with the accompanying drawings in which like parts or elements are denoted by like reference symbols.

### BRIEF DESCRIPTION OF THE DRAWINGS

FIG. 1 is a block diagram showing a public communication system to which the present invention is applied;

FIG. 2 is a block diagram showing a basic configuration of a W-CDMA system shown in FIG. 1;

FIG. 3 is a block diagram showing a radio base station apparatus of the W-CDMA system of FIG. 2;

FIG. 4 is a block diagram showing a configuration of a medical (fire service) network;

FIG. 5 is a block diagram showing a configuration of a high function mobile communication terminal used in the public communication system of FIG. 1;

FIG. 6 is a block diagram showing a configuration of a medical (fire service) high function mobile communication terminal used in the public communication system of FIG. 1;

FIG. 7 is a diagrammatic view illustrating a configuration of a service class table used in the public communication system of FIG. 1; and

FIGS. 8a and 8b are block diagrams illustrating different examples of allocation of base band resources.

### DESCRIPTION OF THE PREFERRED EMBODIMENT

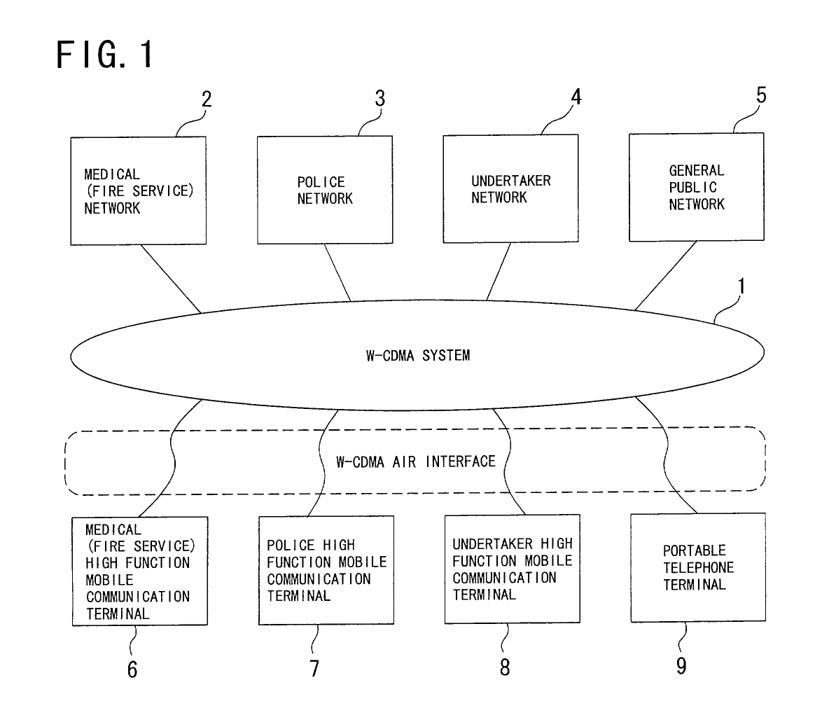

Referring first to FIG. 1, there is shown a public communication system to which the present invention is applied. The public communication system includes a plurality of communication networks having different service objects from one another such as, for example, a medical (fire service)network 2 for medical and fire services, a police network 3, several undertaker networks 4 (only one is shown in FIG. 1) and a general public network 5 integrated by a W-CDMA (Wideband Code Division Multiplex Access) system 1 to construct a single integrated communication system.

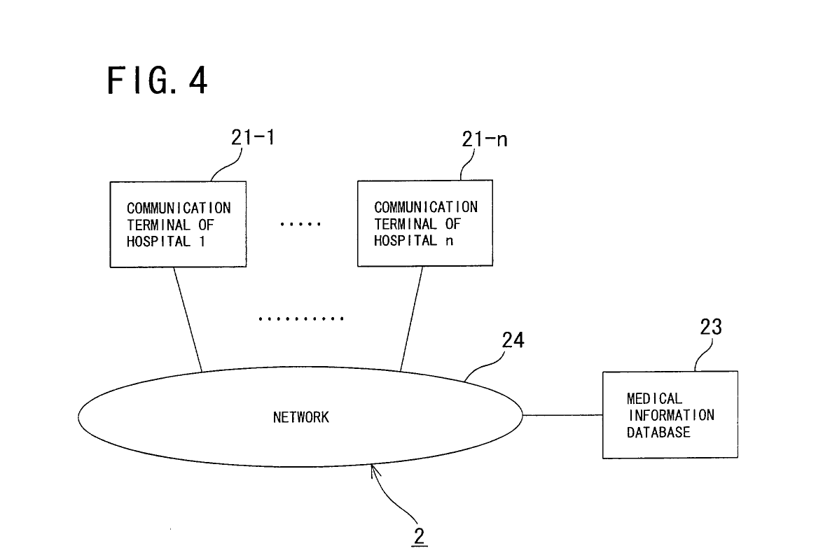

Referring to FIG. 4, the medical (fire service) network 2 includes a plurality of communication terminals 21-1 to 21-n individually installed in different hospitals, a medical information database 23 for updating and storing medical information, and a network 24 which interconnects the communication terminals 21-1 to 21-n and the medical information database 23. Referring back to FIG. 1, the medical (fire service) network 2 is connected to a medical (fire service) high function mobile communication terminal or terminals 6 through the W-CDMA system 1. The air interface of the W-CDMA is used as a radio interface between the medical (fire service) high function mobile communication terminal 6 and the W-CDMA system 1.

The police network 3 has a network for interconnecting a plurality of communication terminals installed in police stations and a police database and is connected to a police high function mobile communication terminal or terminals 7 by the air interface of the W-CDMA through the W-CDMA system 1.

Each of the undertaker networks 4 has a network for interconnecting a plurality of communication terminals installed in various places of business of various undertakers and is connected to undertaker high function mobile communication terminals (only one is shown in FIG. 1) 8 by the air interface of the W-CDMA through the W-CDMA system 1.

The general public network 5 is connected to portable telephone terminals (only one is shown in FIG. 1) 9 by the air interface of the W-CDMA through the W-CDMA system 1.

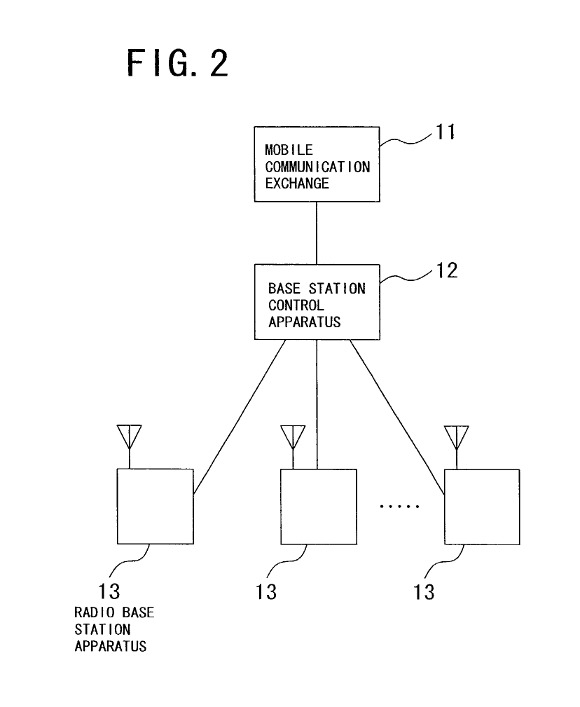

Referring to FIG. 2, the W-CDMA system 1 includes a mobile communication exchange 11, a base station control apparatus 12 and a plurality of radio base station apparatus 13.

The mobile communication exchange 11 has a function of connecting the medical (fire service) network 2, police network 3, undertaker networks 4 and general public network 5 to the W-CDMA system 1.

The base station control apparatus 12 supervises and controls the radio base station apparatus 13.

Each of the radio base station apparatus 13 uses the air interface of the W-CDMA to communicate with various terminals including the medical (fire service) high function mobile communication terminal 6, police high function mobile communication terminal 7, undertaker high function mobile communication terminals 8 and portable telephone terminals 9.

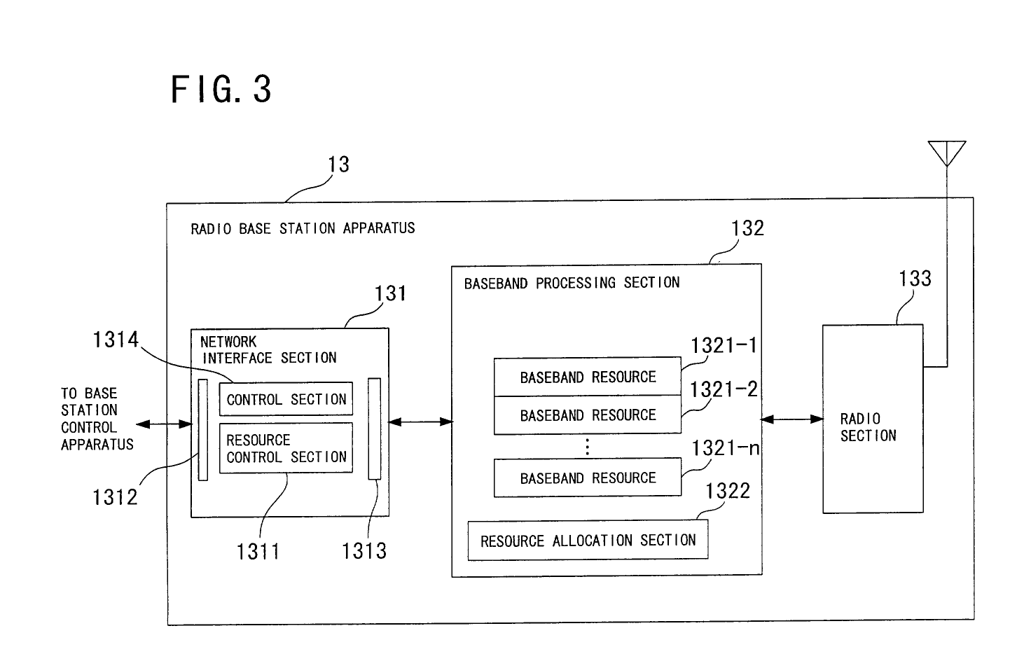

Referring to FIG. 3, each of the radio base station apparatus 13 includes a network interface section 131, a baseband processing section 132 and a radio section 133.

The network interface section 131 includes a transmission-reception section 1312 for transmitting and receiving control data and user data to and from the base station control apparatus 12, a control section 1314 for controlling the entire radio base station apparatus 13 in accordance with the control data received by the transmission-reception section 1312, another transmission-reception section 1313 for transmitting and receiving user data to and from the baseband processing section 132, and a resource control section 1311 for controlling baseband (band) resources to be allocated to the users.

The baseband processing section 132 includes a plurality of baseband resources 1321 (represented as 1321-1, 1321-2, . . . , 1321-n) which are functioning blocks for processing a baseband signal in a unit of a minimum transmission rate, and a resource allocation section 1322 for allocating the baseband resources 1321 to the users under the resource control of the resource control section 1311. The baseband resources 1321 are basic unit band resources which can process the minimum transmission rate.

Each of the baseband resources 1321 includes a downlink channel coding and spreading section for performing a decoding process and a spreading process of downlink user data received from the network interface section 131 and transmitting the resulting user data to the radio section 133, and an uplink despreading and channel decoding section for performing a despreading process, a detection process, a RAKE synthesis process and a decoding process for uplink reception data received from the radio section 133 and transmitting the resulting uplink reception data to the network interface section 131.

The radio section 133 performs digital to analog (D/A) conversion and frequency conversion of downlink user data received from the baseband processing section 132 to obtain a radio frequency (RF) signal and transmitting the RF signal to a high function mobile communication terminal or a portable telephone set of a user. Further, the radio section 133 receives an uplink RF signal from a high function mobile communication terminal or a portable telephone set of a user, performs frequency conversion and analog to digital (A/D) conversion for the received RF signal and transmits the resulting signal to the baseband processing section 132.

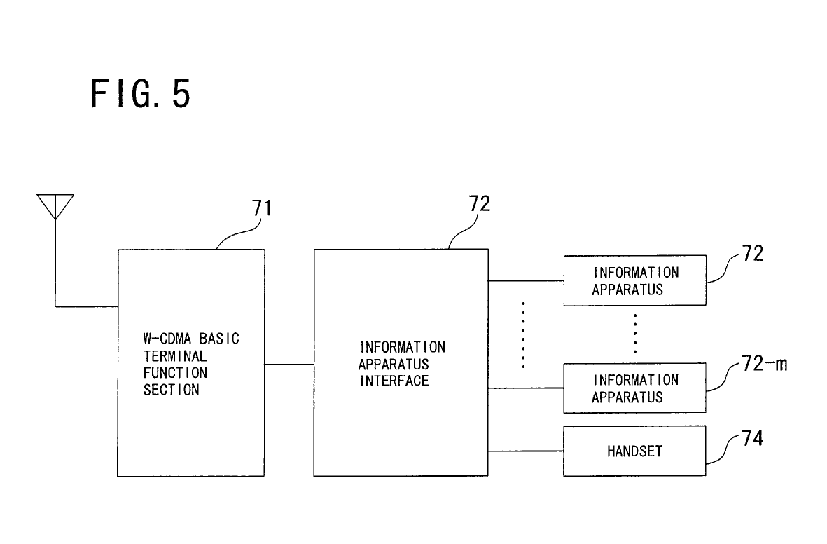

Each of the medical (fire service) high function mobile communication terminal 6, police high function mobile communication terminal 7 and undertaker high function mobile communication terminal 8 is a high function mobile communication terminal for exclusive use for the user. Referring to FIG. 5, the high function mobile communication terminal includes a W-CDMA basic terminal functioning section 71, an information apparatus interface 72, a plurality of information apparatus 73-1 to 73-m, and a handset 74.

The W-CDMA basic terminal functioning section 71 has a function of controlling basic call processes of the W-CDMA system, a function of processing the air interface of the W-CDMA system, a function of sending received downlink user data to the information apparatus interface 72, and a function of receiving data from an information apparatus 73 (73-1 to 73-m) through the information apparatus interface 72 and converting the received data into data for the air interface of the W-CDMA system.

The information apparatus interface 72 has a function of interfacing between the W-CDMA basic terminal function section 71 and the information apparatus 73-1 to 73-m and handset 74 for telephone communication. The information apparatus interface 72 has interface specifications common to all of the information apparatus so that various high function mobile communication terminals may be implemented only by changing the information apparatus 73 (73-1 to 73-m) to be used in accordance with an intended application.

Each of the information apparatus 73-1 to 73-m is an information apparatus for exclusive use for a high function mobile communication terminal and is connected to the W-CDMA basic terminal function section 71 by the information apparatus interface 72 so that it is connected to a network of a communication system connected to the W-CDMA system 1.

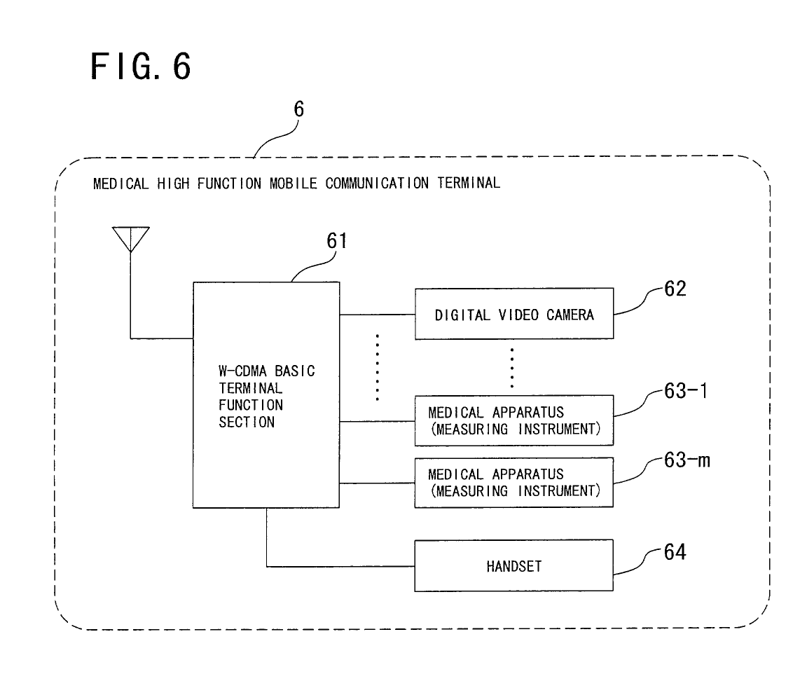

Specifically, referring to FIG. 6, the medical (fire service) high function mobile communication terminal 6 includes a W-CDMA basic terminal function section 61, a digital video camera 62, a plurality of medical apparatus 63-1 to 63-m including a medical measuring instrument, and a handset 64 for telephone communication. The W-CDMA basic terminal function section 61 connects the medical apparatus 63-1 to 63-m and the handset 64 to the W-CDMA system 1 using the air interface of the W-CDMA system.

Subsequently, operation of the public communication system is described in detail with reference to FIGS. 1 to 8.

<Resource Allocation Control>

First, description is given of a manner of allocation of resources to user terminals, that is, to the medical (fire service) high function mobile communication terminal 6, police high function mobile communication terminal 7, undertaker high function mobile communication terminals 8 and portable telephone terminals 9.

The mobile communication exchange 11 has a service class table 111 which indicates telephone number groups into which the users are classified based on the telephone numbers of the users such as, for example, the area codes, service classes provided individually to the telephone number groups and having different priority levels of services from one another, and methods of controlling resources to the individual service classes.

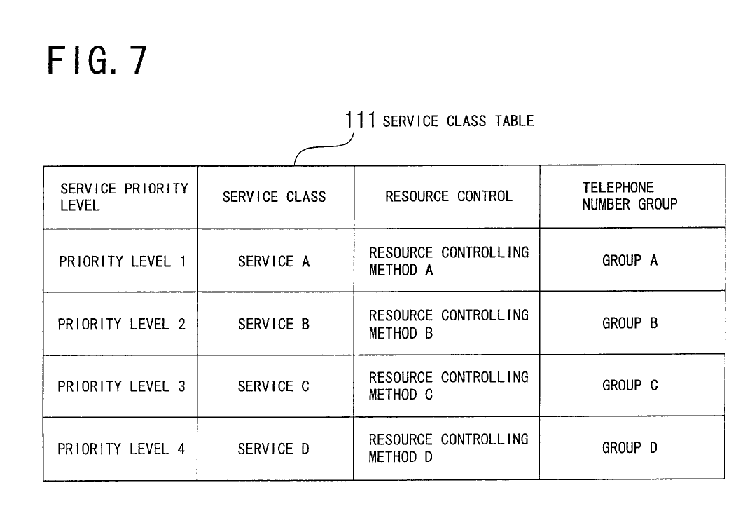

For example, the mobile communication exchange 11 provides, using such a service class table 111 as shown in FIG. 7, services A, B, C and D to the telephone number groups A, B, C and D, respectively, and instructs the base stations 13 to control resources using the resource controlling methods corresponding to the services A, B, C and D, that is, using the resource controlling methods, A, B, C and D, respectively. Here, the priority levels are determined for the services A, B, C and D in this order, that is, the priority levels 1, 2, 3 and 4 are determined in a descending order for the services A, B, C and D, respectively.

The network interface section 131 has a current service providing table indicating in what service class a service is being currently provided to each user.

If the mobile communication exchange 11 recognizes origination of a call from a user terminal, then it refers to the service class table 111 to recognize a service class based on the telephone number of the user terminal and instructs the radio base station apparatus 13 of a pertaining resource controlling method.

The network interface section 131 of the radio base station apparatus 13 controls resources based on the instruction from the mobile communication exchange 11. The radio base station apparatus 13 controls the resources based on such a plurality of control ranks as described below, here, based on control ranks 1, 2 and 3.

In the control rank 1, the network interface section 131 controls that a resource which can process, in the worst case, a user minimum transmission rate UserMinRate is secured.

In the control rank 2, the network interface section 131 controls so that a resource is secured which can process, in the worst case, a service medium transmission rate UserMedRate of the user, that is, a service medium transmission rate which is an intermediate rate equal to or higher than the user minimum transmission rate UserMinRate but equal to or lower than a user maximum transmission rate UserMaxRate.

In the control rank 3, the network interface section 131 controls so that a resource which can process the maximum transmission rate UserMaxRate which the user can use is secured.

When the network interface section 131 receives an instruction of one of the resource controlling methods A, B, C and D from the mobile communication exchange 11, it controls resources making use of the control ranks described above.

In particular, if the network interface section 131 receives an instruction of control in accordance with the resource controlling method A from the mobile communication exchange 11, then it attempts to secure, for a user, a resource which can process the maximum transmission rate UserMaxRate in accordance with the control rank 3. If such a resource as just described is successfully secured as a result of the attempt, then the network interface section 131 connects the user terminal and stores the telephone number of the connected user terminal and information that the service class for the user terminal is the service class A into the current service providing table. If the network interface section 131 fails to secure such a resource as described above, then it refers to the current service providing table to search for the telephone number of another user terminal which enjoys a service of a service class of a lower priority level, that is, of the service class B, C or D and either changes the resource allocated to the user terminal or disconnects the user terminal to secure the resource which has been utilized by the user terminal.

On the other hand, if the network interface section 131 receives an instruction of control in accordance with the resource controlling method from the mobile communication exchange 11, then it first attempts to secure a resource which can process the maximum transmission rate UserMaxRate in accordance with the control rank 3.

If the network interface section 131 successfully secures such a resource as described above, then it starts connection of the user terminal and updates the current service providing table or maintains its connection. On the other hand, if the network interface section 131 fails to secure such a resource as described above, then it attempts to secure a resource which can process the service medium transmission rate UserMedRate of the user in accordance with the control rank 2.

Then, if the network interface section 131 successfully secures such a resource as described above, then it starts connection of the user terminal and updates the current service providing table or maintains its connection. On the other hand, if the network interface section 131 fails to secure such a resource as described above, then it attempts to secure a resource which can process the minimum transmission rate UserMinRate of the user in accordance with the control rank 1.

Then, if the network interface section 131 successfully secures such a resource as described above, then it starts connection of the user terminal and updates the current service providing table or maintains its connection. On the other hand, if the network interface section 131 fails to secure such a resource as described above, then it refers to the current service providing table to search for the telephone number of another user terminal which enjoys a service of a service class of a lower priority level, that is, the service class C or D and either changes the resource allocated to the user terminal or disconnects the user terminal to secure the resource which has been utilized by the user terminal.

If the network interface section 131 receives an instruction of control in accordance with the resource controlling method C from the mobile communication exchange 11, then it first attempts to secure are source which can process the maximum transmission rate UserMaxRate in accordance with the control rank 3.

If the network interface section 131 successfully secures such a resource as described above, then it starts connection of the user terminal and updates the current service providing table or maintains its connection. On the other hand, if the network interface section 131 fails to secure such a resource as described above, then it attempts to secure a resource which can process the service medium transmission rate UserMedRate of the user in accordance with the control rank 2.

Then, if the network interface section 131 successfully secures such a resource as described above, then it starts connection of the user terminal and updates the current service providing table or maintains its connection. On the other hand, if the network interface section 131 fails to secure such a resource as described above, then it refers to the current service providing table to search for the telephone number of another user terminal which enjoys a service of a service class of a lower priority rank, that is, the service class D and disconnects the user terminal to secure the resource which has been utilized by the user terminal. If a resource cannot be secured even with this, the network interface section 131 does not connect the user terminal.

If the network interface section 131 receives an instruction of control in accordance with the resource controlling method D from the mobile communication exchange 11, then it first attempts to secure a resource which can process the maximum transmission rate UserMaxRate in accordance with the control rank 3.

If the network interface section 131 successfully secures such a resource as described above, then it starts connection of the user terminal and updates the current service providing table. On the other hand, if the network interface section 131 fails to secure such a resource as described above, then it does not connect the user terminal or disconnect the terminal which is in a connected state.

If contention in securing of resources between different users having different priority levels, then the network interface section 131 secures a resource so that a user having a higher priority level may have a higher (or equal) transmission rate. However, if a resource cannot be secured in this manner, then the network interface section 131 cuts the connection of the user having a lower priority level and allocates the resource which has been secured for the user of the lower priority level.

The control when contention in securing of resources occurs is described in more detail in connection with two particular cases.

As the first particular case, control when a user U1 who belongs to the telephone number group D of the priority level 4 is communicating and another user U2 who belongs to the telephone number group of a higher priority level 3 originates a call to request for connection, that is, request for a resource is described.

The user U1 who belongs to the telephone number group D is communicating at the maximum transmission rate UserMaxRate 1 with a resource secured in accordance with the control rank 3 by the resource controlling method D. In this instance, if the user U2 who belongs to the telephone number group C originates a call to issue a request for connection, that is, a request for a resource, then the network interface section 131 receives an instruction of control in accordance with the resource controlling method from the mobile communication exchange 11.

Upon reception of the instruction, the network interface section 131 first attempts to secure a resource which can process the maximum transmission rate UserMaxRate 2 with the control rank 3.

If the network interface section 131 successfully secures such a resource as just described, then it allocates the resource which can process the maximum transmission rate UserMaxRate 2 to the terminal of the user U2 and connects the terminal of the user U2. The terminal of the user U2 starts communication at the maximum transmission rate UserMaxRate.

On the other hand, if the network interface section 131 fails to secure such a resource as described above, then it attempts to secure a resource which can process the service medium transmission rate UserMedRate 2 in accordance with the control rank 2.

If the network interface section 131 can secure a resource so that the service medium transmission rate UserMedRate 2≧maximum transmission rate UserMaxRate 1 may be satisfied, then it allocates the resource which can process the service medium transmission rate UserMedRate 2 to the terminal of the user U2 and connects the terminal of the user U2. Further, for the terminal of the user U1, the network interface section 131 continues to secure the resource allocated to the same and capable of processing the maximum transmission rate UserMaxRate 1 and maintains the connection. After all, the terminal of the user U2 starts communication at the service medium transmission rate UserMedRate 2 while the terminal of the user U1 continues to communicate at the maximum transmission rate UserMaxRate 1.

On the other hand, if the network interface section 131 cannot secure, as a result of the attempt described above, a resource so that the service medium transmission rate UserMedRate 2≧maximum transmission rate UserMaxRate 1 may be satisfied, then it disconnects the terminal of the user U1 which belongs to the telephone number group D having a priority level lower than that of the telephone number group C to which the terminal of the user U2 belongs, releases the resource which has been allocated to the user U1, secures the resource which can process the service medium transmission rate UserMedRate 2, allocates the resource to the terminal of the user U2 and connects the terminal of the user U2. After all, the terminal of the user U2 starts communication at the service medium transmission rate UserMedRate 2 while the terminal of the user U1 is disconnected.

Now, description is given of control when, while the user U3 who belongs to the telephone number group C of the priority level 3 is communicating, the user U4 who belongs to the telephone number group B of the priority level 2 originates a call to issue a request for connection, that is, a request for a resource as the second particular example.

The user U3 who belongs to the telephone number group C is communicating through a connection at the maximum transmission rate UserMaxRate 3 with a resource secured with the control rank 3 by the resource controlling method C. In this instance, if the user U4 who belongs to the telephone number group B originates a call to issue a request for connection, that is, a request for a resource, then the network interface section 131 receives an instruction to effect control with the resource controlling method B from the mobile communication exchange 11.

In response to the instruction received, the network interface section 131 first attempts to secure a resource which can process the maximum transmission rate UserMaxRate 4 with the control rank 3.

If the network interface section 131 successfully secures such a resource as described above, then it allocates the resource to the terminal of the user U4 and connects the terminal of the user U4. The terminal of the user U4 communicates at the maximum transmission rate UserMaxRate 4.

On the other hand, if the network interface section 131 fails to secure such a resource as described above, then it attempts to secure a resource which can process the service medium transmission rate UserMedRate 4 with the control rank 2.

If a resource can be secured so that the service medium transmission rate UserMedRate 4≧maximum transmission rate UserMaxRate 3 is satisfied, then the network interface section 131 allocates the resource which can process the service medium transmission rate UserMedRate 4 to the terminal of the user U4 and connects the terminal of the user U4. Further, for the terminal of the user U3, the network interface section 131 continues to secure the resource currently allocated to the terminal of the user U3 as it is and maintains the connection.

After all, the terminal of the user U4 starts communication at the service medium transmission rate UserMedRate 4 while the terminal of the user U3 continues the communication at the maximum transmission rate UserMaxRate 3.

On the other hand, if a resource cannot be secured through the attempt so that the service medium transmission rate UserMedRate 4≧maximum transmission rate UserMaxRate 3 may be satisfied, then the network interface section 131 attempts to secure a resource which can process the minimum transmission rate UserMinRate 4 with the control rank 1.

If such a resource as just described can be secured through the attempt, then the network interface section 131 allocates the resource to the terminal of the user U4 and connects the terminal of the user U4.

The terminal of the user U4 starts communication at the minimum transmission rate UserMinRate 4 while the terminal of the user U3 continues its communication at the maximum transmission rate UserMaxRate 3.

On the other hand, if such a resource as described above cannot be secured, that is, if a resource which can process the minimum transmission rate UserMinRate 4 cannot be secured either, then the network interface section 131 changes the resource allocation to the terminal of the user U3 which is currently communicating at the maximum transmission rate UserMaxRate 3. In particular, the network interface section 131 re-allocates a resource which can process the lower transmission rate UserMedRate 3 with the control rank 2 to the terminal of the user U3. The terminal of the user U3 continues to communicate at the service medium transmission rate UserMedRate 3 changed from the maximum transmission rate UserMaxRate 3. Consequently, a free resource is produced.

Then, the network interface section 131 attempts to secure a resource which can process the maximum transmission rate UserMaxRate 4 again.

If such a resource as described above is secured successfully as a result of the attempt, then the network interface section 131 allocates the resource to the terminal of the user U4 and connects the terminal of the user U4. The terminal of the user U4 communicates at the maximum transmission rate UserMaxRate 3.

On the other hand, if such a resource as described above cannot be secured, then the network interface section 131 attempts to secure a resource which can process the service medium transmission rate UserMedRate 4 with the control rank 2.

If a resource can be secured so that the service medium transmission rate UserMedRate 4≧maximum transmission rate UserMaxRate 3 may be satisfied, then the network interface section 131 allocates the resource which can process the service medium transmission rate UserMedRate 4 to the terminal of the user U4 and connects the terminal of the user U4. Further, for the terminal of the user U3, the network interface section 131 continues to secure the resource currently allocated to the terminal of the user U3 and maintains the connection. After all, the terminal of the user U4 starts communication at the service medium transmission rate UserMedRate 4 while the terminal of the user U3 continues its communication at the service medium transmission rate UserMedRate 3.

On the other hand, if a resource cannot be secured through the attempt so that the service medium transmission rate UserMedRate 4≧maximum transmission rate UserMaxRate 3 may be satisfied, then the network interface section 131 attempts to secure a resource which can process the minimum transmission rate UserMinRate 4 with the control rank 1.

If a resource which can process the user minimum transmission rate UserMinRate 4 can be secured through the attempt, then the network interface section 131 allocates the resource to the terminal of the user U4 and connects the terminal of the user U4. After all, the terminal of the user U4 starts communication at the user minimum transmission rate UserMinRate 4 while the terminal of the user U3 continues its communication at the service medium transmission rate UserMedRate 3.

On the other hand, if a resource which can process the user minimum transmission rate UserMinRate 4 cannot be secured through the attempt, then the network interface section 131 disconnects the terminal of the user U3 which is currently communicating at the service medium transmission rate UserMedRate 3 to release the resource which has been allocated to the terminal of the user U3. Then, the network interface section 131 secures the resource which can process the user minimum transmission rate UserMinRate 4, allocates the resource to the terminal of the user U4 and connects the terminal of the user U4. After all, the terminal of the user U4 starts communication at the user minimum transmission rate UserMinRate 4 while the terminal of the user U3 is disconnected.

<Allocation of Resources>

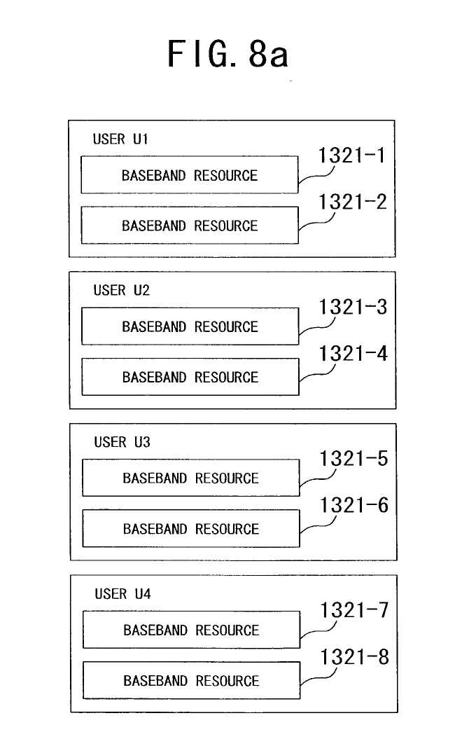

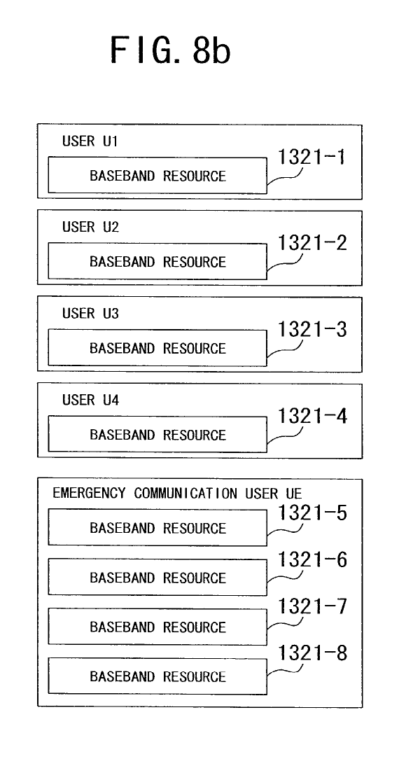

Subsequently, description is given of in what manner the baseband processing section 132 allocates resources through resource allocation control of the network interface section 131. FIGS. 8a and 8b illustrate allocation of baseband resources.

The resource allocation section 1322 of the baseband processing section 132 allocates the baseband resources 1321 to the terminals of the users based on resource control by the resource control section 1311 of the network interface section 131. Here, the baseband resources 1321 are basic unit band resources which can process the minimum transmission rate.

When resources are to be allocated to a plurality of terminals of different users having an equal priority level, the resource allocation section 1322 allocates the baseband resources 1321 which can process the minimum transmission rate uniformly to the terminals of the users under the control of the resource control section 1311. For example, as seen in FIG. 8a, when the terminal of the user U1, the terminal of the user U2, the terminal of the user U3 and the terminal of the user U4 have an equal priority level, the resource allocation section 1322 allocates, from among all baseband resources owned thereby (here, eight baseband resources), two baseband resources of the baseband resource 1321-1 and the baseband resource 1321-2 to the terminal of the user U1, allocates two baseband resources of the baseband resource 1321-3 and the baseband resource 1321-4 to the terminal of the user U2, allocates two baseband resources of the baseband resource 1321-5 and the baseband resource 1321-6 to the terminal of the user U3, and allocates two baseband resources of the baseband resource 1321-7 and the baseband resource 1321-8 to the terminal of the user U4. Each of the terminals of the users U1, U2, U3 and U4 communicates at a rate equal to twice the minimum transmission rate.

While the terminals of the users U1, U2, U3 and U4 are communicating at the equal rate in this manner, if the terminal of an emergency communication user UE which necessitates communication at a rate equal to four times the minimum transmission rate originates a call to issue a request for connection, that is, a request for a resource, then the network interface section 131 performs resource control using the resource control section.

Through the resource control, the resource allocation section 1322 allocates one baseband resource to each of the terminals of the users U1, U2, U3 and U4 which have a lower priority level. In particular, the resource allocation section 1322 allocates the baseband resource 1321-1 to the terminal of the user U1, allocates the baseband resource 1321-2 to the terminal of the user U2, allocates the baseband resource 1321-3 to the terminal of the user U4, allocates the baseband resource 1321-4 to the terminal of the user U4, and decreases the transmission rate of the terminals of the users U1, U2, U3 and U4 to the minimum transmission rate. Then, the resource allocation section 1322 allocates the four baseband resources 1321-5, 1321-6, 1321-7 and 1321-8, which have been allocated to the terminals of the users U1, U2, U3 and U4, to the terminal of the emergency communication user UE which has a higher priority level. The terminal of the emergency communication user UE performs emergency communication at a rate equal to four times the minimum transmission rate.

As described above, the QoS (service quality) control is performed so that the transmission rate of users having a lower priority level is lowered and another user having a higher priority level can communicate at a desired transmission rate. Consequently, a service is provided to a user in accordance with a priority level of the user.

<Operation of the Entire Public Communication System>

Operation of the public communication system when it connects a high function mobile communication terminal to a network for exclusive use and provides a service to the high function mobile communication terminal.

Operation is described taking communication between the medical (fire service) high function mobile communication terminal 6 and the medical (fire service) network 2 as an example.

The medical (fire service) high function mobile communication terminal 6 originates a call from the handset 64 to issue a request for connection to the medical (fire service) network 2, that is, a request for a resource.

When the mobile communication exchange 11 of the W-CDMA system 1 recognizes the call origination from the medical (fire service) high function mobile communication terminal 6, it refers to the service class table 111 to identify a service class based on the telephone number of the medical (fire service) high function mobile communication terminal 6 and issues an instruction of a resource controlling method to the base station 13.

The network interface section 131 and the baseband processing section 132 of the base station 13 control resources based on the instruction from the mobile communication exchange 11 and allocate a designated number of baseband resources 1321 to the medical (fire service) high function mobile communication terminal 6.

Then, the mobile communication exchange 11 of the W-CDMA system 1 connects the medical (fire service) high function mobile communication terminal 6 to the medical (fire service) network 2.

The medical (fire service) high function mobile communication terminal 6 is connected to the W-CDMA system 1 by the air interface of the W-CDMA system and then connected to the medical (fire service) network 2.

The medical (fire service) high function mobile communication terminal 6 connected to the medical (fire service) network 2 transmits a medical high speed image from the digital video camera 62 and medical data from a medical apparatus 63 (63-1 to 63-m) to a communication terminal 21 (21-1 to 21-n) of a hospital and the medical information database 23 connected to the medical (fire service) network 2. Further, the medical apparatus 63 of the medical (fire service) high function mobile communication terminal 6 receives medical data from the communication terminal 21 of the hospital or the medical information database 23 and performs medical treatment.

Further, where the medical (fire service) high function mobile communication terminal 6 is carried on an ambulance car of a fire station, it accesses the medical information database 23 in which medical information such as applicable medical departments, the number of free beds, information of whether or not an emergency case is acceptable and so forth of each hospital on the medical (fire service) network 2 to search for an optimum hospital, and directly transmits an image of the patient picked up by the digital video camera 62 and medical data of the patient from the medical apparatus 63 to the communication terminal 21 of the searched out hospital. Consequently, appropriate medical treatment can be performed further rapidly and accurately.

Further, the public communication system connects a high function mobile communication terminal, which includes the information apparatus interface 72 having an interface common to the various information apparatus 73, to the pertaining network through operation similar to that described hereinabove and provides a high speed service required by the high function mobile communication terminal. In this instance, if the information apparatus 73 is changed in accordance with its application, then it can cope flexibly with various communication systems.

While a preferred embodiment of the present invention has been described using specific terms, such description is for illustrative purposes only, and it is to be understood that changes and variations may be made without departing from the spirit or scope of the following claims.

What is claimed is:

1. A public communication system, comprising:
a plurality of communication networks having different service objects from each other;
a plurality of mobile communication terminals for communicating with said communication networks; and
a W-CDMA system for integrally connecting said communication networks and using the W-CDMA to set, individually for said mobile communication terminals, transmission rates to be used for communication by said mobile communication terminals based on priority levels determined in advance and connect said mobile communication terminals and said communication networks for communication to each other at the set transmission rates.

2. A public communication system as claimed in claim 1, wherein said W-CDMA system includes a mobile communication exchange, a plurality of ratio base station apparatus and a base station control apparatus for communicating with said mobile communication exchange to control said plurality of radio base station apparatus, said mobile communication exchange including network means for connecting said communication networks to each other and terminal and network connection means for connecting said mobile communication terminals to said communication networks, each of said radio base station apparatus including resource controlling means for controlling so that, for each of said mobile communication terminals, a band resource for a transmission rate to be allocated to the mobile communication terminal is secured based on the priority level determined in advance for the mobile communication terminal, resource allocation means for allocating the band resources secured by said resource controlling means individually to said mobile communication terminals, baseband processing means for baseband processing a signal of any of said mobile communication terminals with the band resource allocated to the mobile communication terminal by said resource allocation means, and air interface means for radio interfacing the signal baseband processed by said baseband processing means with the pertaining mobile communication terminal using the W-CDMA air interface.

3. A public communication system as claimed in claim 2, wherein said resource controlling means includes first controlling means for controlling so that at the worst a band resource which can process a minimum transmission rate requested by the pertaining mobile communication terminal is secured, second controlling means for controlling so that at the worst a band resource which can process a medium transmission rate requested by the pertaining mobile communication terminal and higher than the minimum transmission ratio but lower than a maximum transmission rate is secured, and third controlling means for controlling so that a band resource which can process the maximum transmission rate requested by the pertaining mobile communication terminal is secured.

4. A public communication system as claimed in claim 3, wherein said resource controlling means attempts to secure, for the pertaining mobile communication terminal, a band resource which can process the maximum transmission rate by means of said third controlling means and controls, when the band resource cannot be secured, to release another band resource allocated to another one of said mobile communication terminals having a priority level lower than the priority level of the pertaining mobile communication terminal and secure, for the pertaining mobile communication terminal, the band resource which can process the maximum transmission rate.

5. A public communication system as claimed in claim 3, wherein said resource controlling means attempts to secure, for the pertaining mobile communication terminal, a band resource which can process the maximum transmission rate by means of said third controlling means and controls, when the band resource cannot be secured, to change another band resource allocated to another one of said mobile communication terminals having a priority level lower than the priority level of the pertaining mobile communication terminal to a further band resource which can process a lower transmission rate and secure, for the pertaining mobile communication terminal, the band resource which can process the maximum transmission rate.

6. A public communication system as claimed in claim 3, wherein said resource controlling means first attempts to secure, for the pertaining mobile communication terminal, a band resource which can process the maximum transmission rate by means of said third controlling means and then attempts, when the band resource cannot be secured, to secure, for the pertaining mobile communication terminal, another band resource which can process a medium transmission rate by means of said second controlling means, and then controls, when the band resource cannot be secured, to release a further band resource allocated to another one of said mobile communication terminals having a priority level lower than the priority level of the pertaining mobile communication terminal and secure, for the pertaining mobile communication terminal, the band resource which can process the medium transmission rate.

7. A public communication system as claimed in claim 3, wherein said resource controlling means first attempts to secure, for the pertaining mobile communication terminal, a band resource which can process the maximum transmission rate by means of said third controlling means and then attempts, when the band resource cannot be secured, to secure, for the pertaining mobile communication terminal, another band resource which can process a medium transmission rate by means of said second controlling means, and then controls, when the band resource cannot be secured, to change another band resource allocated to another one of said mobile communication terminals having a priority level lower than the priority level of the pertaining mobile communication terminal to a further band resource which can process a lower transmission rate and secure, for the pertaining mobile communication terminal, the band resource which can process the medium transmission rate.

8. A public communication system as claimed in claim 3, wherein said resource controlling means first attempts to secure, for the pertaining mobile communication terminal, a band resource which can process the maximum transmission rate by means of said third controlling means and then attempts, when the band resource cannot be secured, to secure, for the pertaining mobile communication terminal, another band resource which can process a medium transmission rate by means of said second controlling means, and further attempts, when the band resource cannot be secured, to secure, for the pertaining mobile communication terminal, a further band resource which can process the minimum transmission rate by said first controlling means, whereafter said resource controlling means controls, when the band resource cannot be secured, to release a still further band resource allocated to another one of said mobile communication terminals having a priority level lower than the priority level of the pertaining mobile communication terminal and secure, for the pertaining mobile communication terminal, the band resource which can process the minimum transmission rate.

9. A public communication system as claimed in claim 3, wherein said resource controlling means first attempts to secure, for the pertaining mobile communication terminal, a band resource which can process the maximum transmission rate by means of said third controlling means and then attempts, when the band resource cannot be secured, to secure, for the pertaining mobile communication terminal, another band resource which can process a medium transmission rate by means of said second controlling means, and further attempts, when the band resource cannot be secured, to secure, for the pertaining mobile communication terminal, a further band resource which can process the minimum transmission rate by said first controlling means, whereafter said resource controlling means controls, when the band resource cannot be secured, to change a still further band resource allocated to another one of said mobile communication terminals having a priority level lower than the priority level of the pertaining mobile communication terminal to a yet further band resource which can process a lower transmission rate and secure, for the pertaining mobile communication terminal, the band resource which can process the minimum transmission rate.

10. A public communication system as claimed in claim 2, wherein said resource allocation means defines a band resource which can process a minimum transmission rate as a basic unit band resource and allocates, to the pertaining mobile communication terminal, one or a plurality of basic unit band resources under the control of said resource control means.

11. A public communication system as claimed in claim 1, wherein each of said mobile communication terminals includes a W-CDMA basic terminal function section, an information apparatus interface, a plurality of information apparatus and a handset for telephone communication, said W-CDMA basic terminal function section having a function of controlling a basic call process of the W-CDMA, a function of processing the air interface of the W-CDMA, a function of sending downlink user data received from the W-CDMA system to said information apparatus interface, and a function of converting the data into data of the air interface of the W-CDMA, said information apparatus interface having the W-CDMA basic terminal function section and a function of interfacing between said plurality of interface apparatus and the handsets of said mobile communication terminals.

12. A public communication system as claimed in claim 11, wherein the interface apparatus interface of said mobile communication terminals has an interface common to said plurality of information apparatus.

13. A public communication method by a plurality of communication networks having different service objects from each other, a plurality of mobile communication terminals for communicating with said communication networks, and a W-CDMA for integrally connecting said communication networks and using the W-CDMA to connect said mobile communication terminals for communication to each other, comprising:
a network connection step of connecting said communication networks to each other;
a resource controlling step of controlling to secure, for each of said mobile communication terminals, a band resource for a transmission rate to be allocated to the mobile communication terminal based on a priority level determined in advance for the mobile communication terminal;
a resource allocation step of allocating, to each of said mobile communication terminals, the band resource secured by the resource controlling step;
a baseband processing step of baseband processing signals of said mobile communication terminals with the band resources allocated thereto by the resource allocation step;
an air interface step of radio interfacing the signals processed by the baseband processing step individually with said mobile communication terminals using a W-CDMA interface; and
a terminal and network connection step of connecting said mobile communication terminals to said communication networks;
the steps being performed by said W-CDMA system.

14. A public communication method as claimed in claim 13, wherein the resource controlling step includes a first controlling step of controlling so that at the worst a band resource which can process a minimum transmission rate requested by the pertaining mobile communication terminal is secured, a second controlling step of controlling so that at the worst a band resource which can process a medium transmission rate requested by the pertaining mobile communication terminal and higher than the minimum transmission ratio but lower than a transmission rate is secured, and a third controlling step of controlling so that a band resource which can process the maximum transmission rate requested by the pertaining mobile communication terminal is secured.

15. A public communication method as claimed in claim 13, wherein the resource controlling step includes a step of attempting to secure, for the pertaining mobile communication terminal, a band resource which can process a maximum transmission rate by the third controlling step and a step of controlling, when the band resource cannot be secured, to release another band resource allocated to another one of said mobile communication terminals having a priority level lower than the priority level of the pertaining mobile communication terminal and secure, for the pertaining mobile communication terminal, the band resource which can process the maximum transmission rate.

16. A public communication method as claimed in claim 13, wherein the resource controlling step includes a step of attempting to secure, for the pertaining mobile communication terminal, a band resource which can process a maximum transmission rate by the third controlling step and a step of controlling, when the band resource cannot be secured, to change another band resource allocated to another one of said mobile communication terminals having a priority level lower than the priority level of the pertaining mobile communication terminal to a further band resource which can process a lower transmission rate and secure, for the pertaining mobile communication terminal, the band resource which can process the maximum transmission rate.

17. A public communication method as claimed in claim 13, wherein the resource controlling step includes a first step of attempting to secure, for the pertaining mobile communication terminal, a band resource which can process a maximum transmission rate by the third controlling step, a second step of attempting, when the band resource cannot be secured, to secure, for the pertaining mobile communication terminal, another band resource which can process a medium transmission rate by the second controlling step, and a third step of controlling, when the band resource cannot be secured, to release a further band resource allocated to another one of said mobile communication terminals having a priority level lower than the priority level of the pertaining mobile communication terminal and secure, for the pertaining mobile communication terminal, the band resource which can process the medium transmission rate.

18. A public communication method as claimed in claim 13, wherein the resource controlling step includes a first step of attempting to secure, for the pertaining mobile communication terminal, a band resource which can process a maximum transmission rate by the third controlling step, a second step of attempting, when the band resource cannot be secured, to secure, for the pertaining mobile communication terminal, another band resource which can process a medium transmission rate by the second controlling step, and a third step of controlling, when the band resource cannot be secured, to change another band resource allocated to another one of said mobile communication terminals having a priority level lower than the priority level of the pertaining mobile communication terminal to a further band resource which can process a lower transmission rate and secure, for the pertaining mobile communication terminal, the band resource which can process the medium transmission rate.

19. A public communication method as claimed in claim 13, wherein the resource controlling step includes a first step of attempting to secure, for the pertaining mobile communication terminal, a band resource which can process a maximum transmission rate by the third controlling step, a second step of attempting, when the band resource cannot be secured, to secure, for the pertaining mobile communication terminal, another band resource which can process a medium transmission rate by the second controlling step, a third step of attempting, when the band resource cannot be secured, to secure, for the pertaining mobile communication terminal, a further band resource which can process a minimum transmission rate by the first controlling step, and a fourth step of controlling, when the band resource cannot be secured, to release a still further band resource allocated to another one of said mobile communication terminals having a priority level lower than the priority level of the pertaining mobile communication terminal and secure, for the pertaining mobile communication terminal, the band resource which can process the minimum transmission rate.

20. A public communication method as claimed in claim 13, wherein the resource controlling step includes a first step of attempting to secure, for the pertaining mobile communication terminal, a band resource which can process the maximum transmission rate by the third controlling step, a second step of attempting, when the band resource cannot be secured, to secure, for the pertaining mobile communication terminal, another band resource which can process a medium transmission rate by the second controlling step, a third step of attempting, when the band resource cannot be secured, to secure, for the pertaining mobile communication terminal, a further band resource which can process a minimum transmission rate by the first controlling step, and a fourth step of controlling, when the band resource cannot be secured, to change a still further band resource allocated to another one of said mobile communication terminals having a priority level lower than the priority level of the pertaining mobile communication terminal to a yet further band resource which can process a lower transmission rate and secure, for the pertaining mobile communication terminal, the band resource which can process the minimum transmission rate.

21. A public communication method as claimed in claim 13, wherein the resource allocation step defines a band resource which can process a minimum transmission rate as a basic unit band resource and allocates, to the pertaining mobile communication terminal, one or a plurality of basic unit band resources under the control of the resource control step.
